(19) United States
(12) Patent Application Publication
(10) Pub. No.: US 2010/0073245 A1
(43) Pub. Date: Mar. 25, 2010

(54) WIRELESS COMMUNICATION APPARATUS

(75) Inventor: Akira Namba, Tokyo (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/517,055

(22) PCT Filed: Nov. 29, 2007
(86) PCT No.: PCT/JP2007/073091

§ 371 Date: Aug. 20, 2009

(51) Int. Cl. H01Q 1/24

(52) U.S. Cl. 343/702

(57) ABSTRACT

In order to provide a wireless communication apparatus which reduces noises and keeps receiving sensitivity, a stub (5) which has a base end portion (51) electrically connected to a ground connection portion (7) close to an RF circuit (4) and which has a top end portion (52) that is open is formed on a surface layer (10S) of a circuit board (1). In addition, the stub (5) is formed as a ¼λ electric length ground pattern (5) which is constituted by forming a portion of the ground (10) of the circuit board (1) in a peninsular shape. Both wiring between an RF circuit (4) and a chip antenna (3) and wiring between the base end portion (51) of the ¼λ electric length ground pattern (5) and the ground connection portion (7) are connected so as to be the shortest. Further, multiple ¼λ electric length ground patterns are provided as the stub (5) that have resonance with regard to respectively different frequencies, and base end portions of the multiple ¼λ electric length ground patterns are connected to the ground connection portion (7) so as to be the shortest.

### TECHNICAL FIELD

The present invention relates to a wireless communication apparatus.

Priority is claimed on Japanese Patent Applications No. 2006-321531, filed Nov. 29, 2006, and No. 2007-045794, filed Feb. 26, 2007, the content of which is incorporated herein by reference.

### BACKGROUND ART

A card shaped wireless communication terminal (hereinafter, “wireless communication apparatus” or “communication terminal”) in accordance with “PC Card Standard”, which is mainly used by being inserted into, for example, a PCMCIA (Personal Computer Memory Card International Association) card slot, is generally known.

Such a wireless communication apparatus has a problem in which receiving sensitivity is deteriorated due to the influence of noises radiated from a laptop PC, and there is a demand for reducing the influence of such noises.

Here, the problem is explained in detail, the noises generated by a digital circuit of the laptop PC enter into an RF (Radio Frequency) circuit through, for example, a path which is lead to an antenna of the wireless communication apparatus and a path from a ground of a circuit board of the wireless communication apparatus. Therefore, in a conventional case, there was a problem of depressed sensitivity of the wireless communication apparatus, that is, the receiving sensitivity is deteriorated.

Regarding such a problem, there is a technique which improves communication quality by cancelling the noises and which is generally known as a wireless communication apparatus (for example, Patent Document 1) that is constituted from an LSI including: a card interface means of a personal computer; a spectrum-spread/spectrum-reverse-spread means; and a frequency conversion means. [Patent Document 1] Japanese Patent Application, First Publication No. H09-289471 (paragraph 0007, FIG. 1)

However, there is another problem in which a spectrum-spread/spectrum-reverse-spread means cannot be simple and requires a high cost. The present invention was conceived to solve the above-described problems and has an object to provide a wireless communication apparatus that can eliminate elements of increasing cost in the conventional technique and reduce noise.

### DISCLOSURE OF INVENTION

In order to solve the above-described problems, a wireless communication apparatus of the present invention provides, for example, the following solutions.

A first solution is a wireless communication apparatus including: a ground connection portion which is close to an RF circuit; and a stub which has a base end portion electrically connected to the ground connection portion and has a top end portion that is open, wherein the stub is formed on a surface layer of a circuit board.

A second solution is the above-described wireless communication apparatus, wherein the stub is formed as a ¼λ-electric-length-ground-pattern which is constituted by forming a portion of the ground of the circuit board in a peninsular shape, and both a wiring between the RF circuit and a chip antenna and a wiring between the base end portion of the ¼λ-electric-length-ground-pattern and the ground connection portion are arranged to be shortest.

A third solution is the above-described wireless communication apparatus including multiple ¼λ-electric-length-ground-patterns as the stub that has resonance with regard to respectively different frequencies, wherein base end portions of said plurality of ¼λ-electric-length-ground-patterns are connected to the ground connection portion in shortest paths.

A fourth solution is the above-described wireless communication apparatus, wherein the stub is separated from the ground of the circuit board by an insulation portion which has 0.5-2.0 mm width and is independent from the ground at high frequencies.

A fifth solution is the above-described wireless communication apparatus, wherein the stub has a shape of a straight line, a curved line or a spiral.

A sixth solution is the above-described wireless communication apparatus, wherein the stub has a shape including a plurality of straight lines, a plurality of curved lines or a plurality of spirals.

A seventh solution is the above-described wireless communication apparatus, wherein the stub has a shape of a straight line, a curved line or a spiral and is a pattern formed by electrically connecting both a surface layer and a inside layer of the circuit board by using a plurality of vias.

In accordance with the above-described solutions, it is possible to have following advantages.

In accordance with the first solution, the noise is cancelled if there is noise that is conducted via the ground, hence, it is possible to improve the S/N ratio and keep the receiving sensitivity of the wireless communication apparatus so as to be in a preferable condition.

In accordance with the second solution, if a frequency component which is the same as the carrier frequency used by the wireless communication apparatus is included, the frequency component is effectively cancelled by using a ground pattern having an electric length of ¼λ, hence, it is possible to improve the S/N ratio.

In accordance with the third solution, it is possible to obtain a highly improved S/N ratio with regard to multiple and different carrier waves, and hence, it is possible to increase a range in which the wireless communication apparatus is effectively used so as to include multiple and different frequencies.

In accordance with the fourth solution, there is no difficulty to form a conductive pattern which is separated by a band-shaped insulation portion having a 0.5-2.0 mm width and which is independent at comparatively higher frequencies, and hence, there is no further cost due to, for example, additional constitutional portions.

In accordance with the fifth solution, in the wireless communication apparatus which has severe limitations in size, it is possible to achieve an advantage of cancelling noise while solving limitations regarding a case of the wireless communication apparatus, a circuit board and arrangement of small parts and devices.

In accordance with the sixth solution, it is possible to achieve the same function and advantage as the third solution.

In accordance with the seventh solution, in the wireless communication apparatus which has severe limitations of size, it is possible to achieve an advantage of cancelling noises while solving limitations regarding a case of the wireless communication apparatus, a circuit board and arrangement of small parts and devices.

### BRIEF DESCRIPTION OF THE DRAWINGS

FIG. 1 is a drawing showing an outline of an internal constitution of a wireless communication apparatus of the present invention.

FIG. 2A is a plane drawing of an electric length pattern of ¼λ and shows a pattern including straight lines of different length.

FIG. 2B is a plane drawing of an electric length pattern of ¼λ and shows a pattern including curved lines.

FIG. 2C is a plane drawing of an electric length pattern of ¼λ and shows a modified arrangement of FIG. 1.

FIG. 3 is the measured data showing improvement of a noise floor and specially shows a difference of measured results of cases whether or not an electric length pattern of ¼λ is used.

FIG. 4A is a plane drawing showing an electric length pattern of ¼λ in which a surface layer and an internal layer are electrically connected by a via and shows a pattern on a front surface.

FIG. 4B is a plane drawing showing an electric length pattern of ¼λ in which a surface layer and an internal layer are electrically connected by a via and shows a cross section of A-A′.

### DESCRIPTION OF THE REFERENCE SYMBOLS

1 . . . circuit board
2 . . . PCMCIA interface connector
3 . . . chip antenna
4 . . . RF circuit
5 . . . stub (ground pattern of electric length ¼λ), (ground pattern of electric length of ¼λ), (¼λ pattern)
5a-5e . . . ground pattern of electric length ¼λ
6 . . . digital circuit
7 . . . ground connection portion
9 . . . insulation portion
10 . . . ground (of circuit board 1)
10S . . . surface layer (of circuit board 1)
11 . . . wireless communication apparatus
51 . . . base end portion
51′ . . . base end portion (of ground pattern of electric length ¼λ 5a-5e)
52 . . . top end portion
53 . . . first island conductive portion of L1 layer
54 . . . second island conductive portion of L1 layer
55 . . . base end portion of L2 layer
56 . . . first island conductive portion of L2 layer
57 . . . second island conductive portion of L2 layer
71 . . . via electrically connecting between base end portions of L1 layer and L2 layer
72-76 . . . via repeatedly and electrically connecting L1 layer and L2 layer
80 . . . dielectric layer between L1 layer and L2 layer
81-84 . . . dielectric layers between other layers (conductive layers)
E . . . wireless communication apparatus

### BEST MODE FOR CARRYING OUT THE INVENTION

Hereinafter, one embodiment of a wireless communication apparatus of the present invention is explained with reference to the drawings.

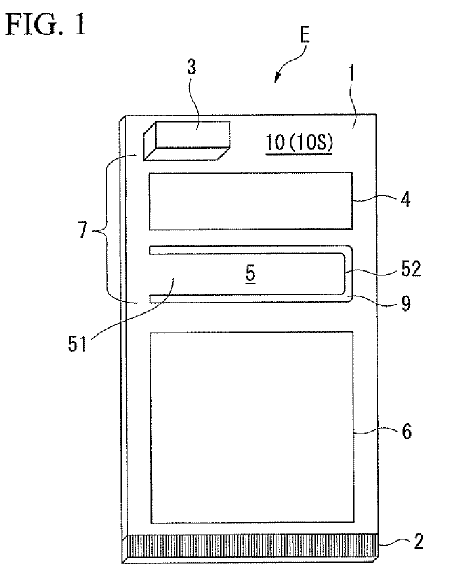

FIG. 1 is a drawing showing an outline of an internal constitution of a wireless communication apparatus (communication terminal) 11 of the present invention. A circuit board 1 in a rectangular shape shown in FIG. 1 is a main portion of a main body without an external shell or case of a wireless communication apparatus E which is a complete product. The circuit board 1 is a printed board generally applied to electric apparatuses. On the circuit board 1, printed circuits made from, for example, a copper foil are formed on an insulating plate, various parts and devices are appropriately mounted and arranged so as to constitute an electric circuit as a communication terminal which can conduct a wireless communication, and such parts and devices are connected via wirings by, for example, soldering.

The circuit board 1 includes a PCMCIA slot 2 provided on a short edge of a rectangle which is a shape of the circuit board 1 shown on a plane. The circuit board 1 includes other constitutional elements, for example, a chip antenna 3 arranged on one corner, an RF circuit 4 and a digital circuit 6. In addition, a stub 5 in a narrow peninsular shape is formed in parallel with a short edge of the circuit board 1 and is formed close to the RF circuit 4.

In explanations below, the stub 5 is called “¼ λ electric length pattern 5”, “¼ λ electric length ground pattern 5” or “¼ λ pattern 5”. In addition, in the stub 5, a certain portion of the ground 10 of the circuit board 1 is separated and surrounded by an insulation portion 9 which has a 0.5-2.0 mm and preferably a 1.0 mm width so as to insulate the certain portion at comparatively higher frequencies, and the ¼ λ pattern 5 is provided which is independent from other portions of the ground. In other words, this certain portion is formed so as to be independent from the ground 10 with regard to high frequencies.

The stub shown in FIG. 1 is one typical example and is formed by the ¼ λ electric length ground pattern 5 (the same reference numeral as the stub) which is constituted by forming a portion of the ground 10 of the circuit board 1 in a peninsular shape. The base end portion 51 of the stub 5 is electrically connected to a ground connection portion 7 which is close to the RF circuit 4. On a front surface 10S of the circuit board 1, the top end portion 52 of the stub 5 is formed so as to be an open end. In other words, a pattern of the stub 5 of a ¼λ electric length is formed by using a copper foil.

In addition, the circuit board 1 is constituted in a manner in which both wiring between the RF circuit 4 and the chip antenna 3 and wiring between the base end portion 51 of the ¼λ pattern 5 and the ground connection portion 7 are the shortest wiring.

When the wireless communication apparatus E is used, the PCMCIA interface connector 2 is inserted into a predetermined hole or slot of, for example, a laptop PC not shown in the drawings, and the PCMCIA interface connector 2 is electrically connected to a high frequency circuit on a circuit board of the laptop PC. The chip antenna 3, to/from a base station for cellular phones (hereinafter, “base station”), transmits/receives radio waves including signals on which signal operations, for example, amplification are conducted by the RF circuit 4 and which are superimposed on carrier waves. The digital circuit 6 is intervenient and is provided for receiving/transmitting digital signals from/to the laptop PC.

It is ideal that the chip antenna can have a high S/N ratio by receiving only radio waves transmitted from the base station without picking up high frequency noise components (hereinafter, “noise” in a simple manner). However, high frequency noises are generated by both high frequency circuits on the circuit board of the laptop PC and the digital circuit 6 of the wireless communication apparatus E, and certain amount of the noises are mixed via the ground 10 of the wireless communication apparatus E, hence, there is harmful effect on desired signals to be received.

If a noise level of such high frequency noises is higher than a normally measured noise level of the RF circuit 4, the S/N ratio between the desired waves to be received from the base station and the noise level is deteriorated. In other words, in such a case, receiving sensitivity for receiving signals from the base station is deteriorated (deteriorated sensitivity).

Here, the chip antenna 3 is explained in detail. The chip antenna 3 has a ¼λ electric length. When a frequency of carrier waves if the wireless communication apparatus E is 1.80 GHz bandwidth, a size of a longer side edge of the ¼λ electric length pattern 5 is approximately “(3·10¹¹)/(4·1.8·10⁹)=42 (mm)”. Such a size is adapted as a standard of a ¼λ electric length pattern length with regard to one side of various antennas that are based on dipole antennas.

As shown in FIG. 1, the wireless communication apparatus E which is used by being inserted into a card slot of a computer provides the ¼λ electric length ground pattern 5 which is substantially in a horseshoe shape starting from a position close to the ground connection portion 7 of the RF circuit 4. In addition, in the wireless communication apparatus E, both wiring between an antenna terminal (not shown in drawings) of the RF circuit 4 and the chip antenna 3 and wiring between an end of the ¼λ electric length ground pattern 5 and the ground connection portion 7 are the shortest wiring.

In addition, on the circuit board 1, the electric length pattern of ¼λ 5 is provided so as to have a pattern length of ¼λ electric length from the ground connection portion 7. In accordance with such a constitution, an ¼λ electric length ground pattern is formed which provides a mirror image or a reflected image with regard to the chip antenna 3 that is ¼λ electric length.

If the noises conducted from the ground pattern 10 include noises having the same frequency component as the carrier frequency used by the wireless communication apparatus E, the stub 5 generates a negative phase and cancels the noises. Therefore, such noises are blocked and are not lead into the antenna terminal (or abbreviated to “input portion”) of the RF circuit 4. Hence, it is possible to improve the S/N ratio and keep the receiving sensitivity of the wireless communication apparatus E so as to be in a preferable condition.

In detail, by providing the ¼λ pattern 5 which forms an open stub, high frequency noise components conducted from the digital circuit 6 to the antenna 3 are totally reflected by the ¼λ pattern 5 and generates negative phase components. On the other hand, a noise canceller effect is achieved in which positive-phase component noises which are lead into the input portion of the ground connection portion 7 are cancelled by the negative-phase components, hence, it is expected that the S/N ratio is improved and the receiving sensitivity of the wireless communication apparatus E can be kept in a preferable condition.

It should be noted that the ground connection portion 7 is a portion at which a ground of the circuit board 1 and one end of the ¼λ pattern 5 are electrically connected. It is preferable to connect the ground connection portion 7 to the input terminal of the RF circuit 4 formed close to the ground connection portion 7 so as to be the shortest distance while providing a pattern of wide area. This is because, if a ground (not shown in drawings) of the input portion of the RF circuit 4 is apart from a connection portion of the ¼λ pattern 5, there is a possibility that noise picked up between them are not cancelled. Therefore, if a pattern of wirings is applied which is integrated at the ground connection portion 7, it is possible to improve a noise cancelling effect.

In accordance with the above-described constitution and advantages, it is possible to decrease harmful effects on the chip antenna 3 from high frequency noises generated by the laptop PC to which the wireless communication apparatus is inserted and other digital circuits 6. Therefore, with regard to signals received from the base station, it is possible to achieve an advantage of keeping deterioration of the receiving sensitivity so as to be the lowest level.

Here, a relationship is explained between a size of a longer side edge of the ¼λ electrical length patter 5 and an advantage of improving the S/N ratio. In order to provide a solution for a case in which the carrier waves of a bandwidth at a frequency of 1.80 GHz applied to the communication terminal E is a source of noises, a longer side edge of the ¼λ electric length pattern 5 shown in FIG. 1 is 42 mm.

In addition it is possible to shorten the stub 5 at first sight, and it is possible to mount electric parts on an area that is vacant.

On the other hand, in a case in which the source of noise is included in the laptop PC, and in which there is a depressed sensitivity, for example, a noise level of a few dB, improvement by using the ¼λ electric length pattern 5 naturally varies if the laptop PC is different. This is because frequency and strength of the radiated high frequency noises vary with each laptop PC. Therefore, it is preferable to provide a noise solution that fits the source of noises.

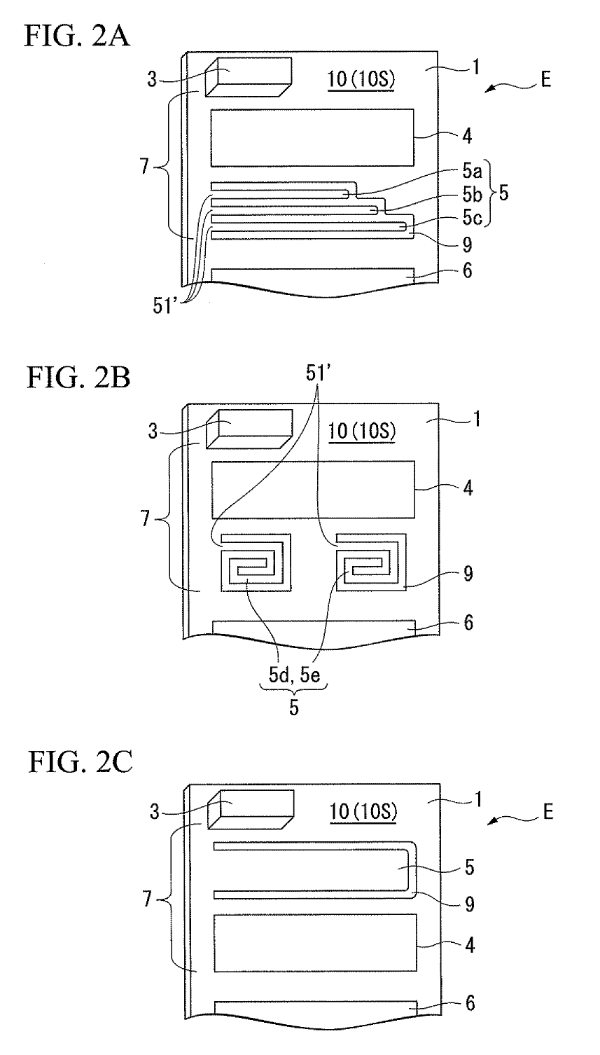

FIGS. 2A-2C are plane drawings of electric length patterns of ¼λ, FIG. 2A shows a pattern including straight lines of different length, FIG. 2B shows a pattern including curved lines, and FIG. 2C shows a modified arrangement applied to FIG. 1. As shown in FIG. 2A, each of patterns of straight lines has a different length and has one end connected at the ground connection portion 7, and hence, the ¼λ electric length pattern 5 is formed which includes ¼λ electric length patterns 5a, 5b and 5c that have resonance with regard to multiple frequencies. The ¼λ electric length ground pattern 5a is comparatively short and has resonance with regard to a comparatively short wavelength, the ¼λ electric length ground pattern 5c is comparatively long and has resonance with regard to a comparatively long wavelength, and ¼λ electric length ground pattern 5b is an intermediate. In addition, in FIG. 2B showing a curved line pattern, ¼λ electric length ground patterns 5d and 5e in coil or spiral shapes form shortening coils. Here, base end portions 51′ of ¼λ electric length ground patterns 5a-5e are connected to the ground connection portion 7 so as to be the shortest distance.

A modified arrangement applied to FIG. 1 shown in FIG. 2C is an arrangement in which, from a view point of the chip antenna 3, positions of the RF circuit 4 and the ¼λ electric length patterns 5 are changed. Here, a pattern of wirings is integrated at the ground connection portion 7, and it is possible to improve a noise cancelling effect.

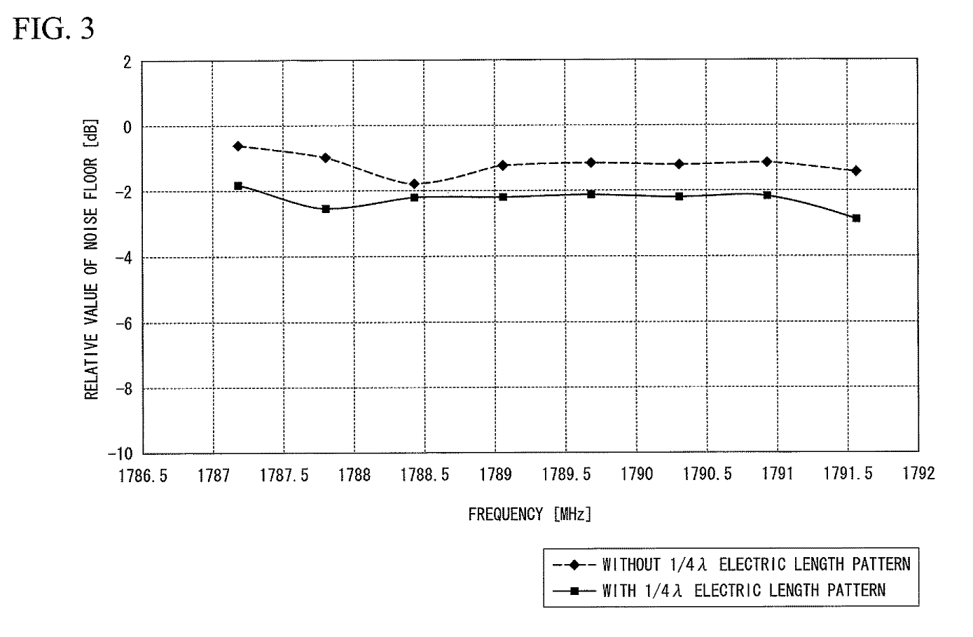

FIG. 3 is the measured data showing improvement of a noise floor and specifically shows a difference of measured results of cases whether or not an electric length pattern of ¼λ is used. In accordance with the measured data, by providing the electric length pattern of ¼λ, an positive effect, that is, improvement of approximately 1 dB is observed. It should be noted that such improvement differs with regard to different laptop PCs which have a different frequency and noise level, and hence, the data shown in FIG. 3 is an example.

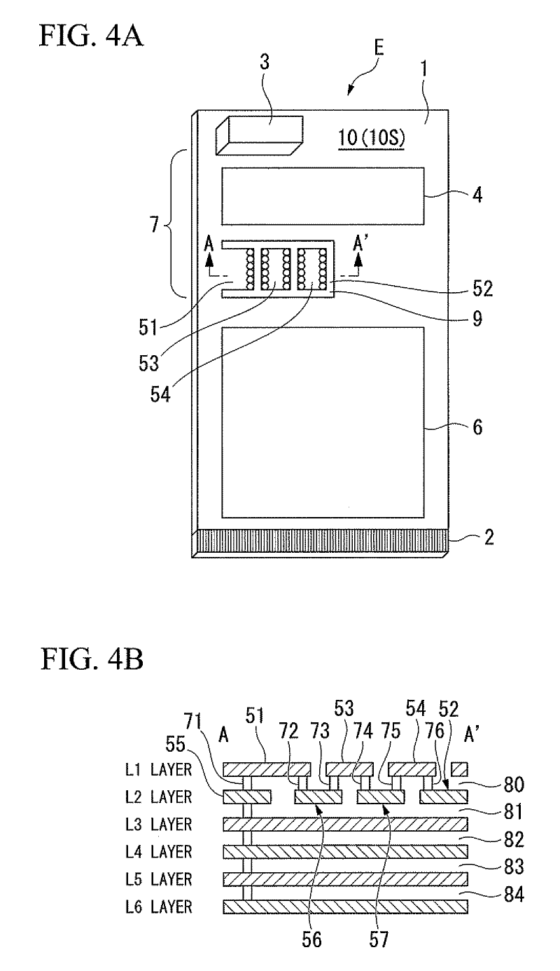

FIG. 4A is a plane drawing showing an electric length pattern of ¼λ in which a surface layer and an internal layer are electrically connected by a via and shows a pattern on a front surface.

FIG. 4B is a plane drawing showing an electric length pattern of ¼λ in which a surface layer and an internal layer are electrically connected by a via and shows a cross section of A-A′. It should be noted that in FIG. 4B, a surface layer (L1 layer) is electrically connected to an L2 layer by using multiple via 72, the L2 layer is electrically connected to the L1 layer by using multiple vias 73, and the L1 layer is electrically connected to the L2 layer by using multiple vias 74. Regarding via 75 and 76, the same constitution is applied. Dielectric layers are filled between each layer (conductive layer). In addition, the L1 layer provides conductive portions 53 and 54 in island shape. The conductive portions in island shape are respectively and electrically connected to the L2 layer. In other words, in a direction from A to A′, the L1 layer and the L2 layer are alternately connected in this order. In such a manner, layers are connected in a three-dimensionally zigzag state, and it is possible to effectively use a space of the circuit board 1.

It should be noted that, a shape, combination, and the like of constitutional members shown in the above-described embodiment are one example, and it is possible to apply various changes to the embodiment, for example, addition, deletion, and replacement of constitutional elements in order to satisfy requirements of a design if it is included in a basic concept of the present invention.

### INDUSTRIAL APPLICABILITY

In accordance with the present invention, it is possible to provide a wireless communication apparatus that is cost effective and can reduce noise.

1. A wireless communication apparatus comprising:
a ground connection portion which is close to an RF circuit; and
a stub which has a base end portion electrically connected to the ground connection portion and has a top end portion that is open, wherein
the stub is formed on a surface layer of a circuit board.

2. A wireless communication apparatus according to claim 1, wherein
the stub is formed as a ¼λ-electric-length-ground-pattern which is constituted by forming a portion of the ground of the circuit board in a peninsular shape, and
both a wiring between the RF circuit and a chip antenna and a wiring between the base end portion of the ¼λ-electric-length-ground-pattern and the ground connection portion are arranged to be shortest.

3. A wireless communication apparatus according to claim 1 comprising a plurality of ¼λ-electric-length-ground-patterns as the stub that has resonance with regard to respectively different frequencies, wherein
base end portions of said plurality of ¼λ-electric-length-ground-patterns are connected to the ground connection portion in shortest paths.

4. A wireless communication apparatus according to claim 1, wherein
the stub is separated from the ground of the circuit board by an insulation portion which has 0.5-2.0 mm width and is independent from the ground at high frequencies.

5. A wireless communication apparatus according to claim 1, wherein
the stub has a shape of a straight line, a curved line or a spiral.

6. A wireless communication apparatus according to claim 1, wherein
the stub has a shape including a plurality of straight lines, a plurality of curved lines or a plurality of spirals.

7. A wireless communication apparatus according to claim 1, wherein
the stub has a shape of a straight line, a curved line or a spiral and is a pattern formed by electrically connecting both a surface layer and a inside layer of the circuit board by using a plurality of vias.
